(19) United States
(12) Patent Application Publication
(10) Pub. No.: US 2020/0284048 A1
(43) Pub. Date: Sep. 10, 2020

(54) ARTIFICIAL TILE AND PREPARATION METHOD AND APPLICATION THEREOF

(71) Applicant: Zhejiang Tianzhen Bamboo & Wood Development Co., Ltd., Huzhou (CN)

(72) Inventor: Qinghua Fang, Huzhou (CN)

(21) Appl. No.: 16/407,629

(22) Filed: May 9, 2019

(30) Foreign Application Priority Data
Mar. 7, 2019 (CN) 201910172445.0

(51) Int. Cl. E04F 15/10; B32B 27/30; B44C 5/04

(52) U.S. Cl. CPC E04F 15/107; B32B 2419/04; B44C 5/04; B32B 27/304

(57) ABSTRACT

An artificial tile is provided for use as a building decoration material. The artificial tile includes a glass magnesium plate, an upper hard layer, a lower hard layer, and a UV layer disposed on the surface of the upper hard layer. The hard layer is disposed between the glass magnesium plate layer and the UV layer, so that the hard layer can not only serve as a connecting layer to promote the connection between the UV layer and the glass magnesium plate, but also serve as a supporting layer to offset the influence of temperature and external force on the glass magnesium plate, to prevent the glass magnesium plate from being deformed under the action of the temperature or the external force, thereby making the conventional UV layer also have anti-scratch and anti-slip functions while having an antifouling function.

### CROSS-REFERENCE TO RELATED APPLICATION

This application claims priority to Chinese Patent Application No. 201910172445.0, filed Mar. 7, 2019. The above-mentioned patent application is incorporated herein by reference in its entirety.

### TECHNICAL FIELD

The present invention relates to building materials, and more particularly, relates to an artificial tile and related methods.

### BACKGROUND

Tiles are the generic term for building or decorative materials such as acid-resistant and alkali-resistant porcelain or stone. Existing tiles are made of clay, quartz sand and other raw materials, which are prepared by grinding, mixing, pressing, glazing and sintering. The tiles have excellent acid and alkali resistance and moisture resistance; however, when used as floor decoration materials, the tiles are hard in touch with the feet, poor in thermal insulation property, prone to condense moisture in wet weather, thereby being slipperier, and have radioactive contamination, so the conventional tiles are gradually replaced by wooden floors. Compared with the tiles, the wooden floor has the advantages of comfortable touch with the feet and desirable thermal insulation property, but a UV layer of the wooden floor is easily damaged. Therefore, it is still very necessary to develop novel floor boards.

In this regard, it would be desirable to provide an artificial tile that provides desirable properties in the same fashion as a wooden floor, including the provision of a UV layer that has excellent scratch resistance.

### SUMMARY

To achieve the above purposes and solve the technical defects in the art, the present invention provides the following technical solution, in one embodiment. An artificial tile is provided and includes a glass magnesium plate, an upper hard layer, a lower hard layer, and a UV layer disposed on the surface of the upper hard layer, where the upper hard layer and the lower hard layer are disposed on the upper surface and the lower surface of the glass magnesium plate respectively.

In one aspect, the artificial tile further includes an abrasion-resistant layer and/or a color layer disposed between the upper hard layer and the UV layer.

In another aspect, when the abrasion-resistant layer and the color layer are disposed between the upper hard layer and the UV layer, the abrasion-resistant layer is connected with the UV layer, and the color layer is connected with the upper hard layer.

In a further aspect, the artificial tile further includes a back cushion disposed on the surface of the lower hard layer.

In yet another aspect, the thickness of the upper hard layer and the thickness of the lower hard layer are independently 1.5-2.5 mm.

In one aspect, the hardness of the upper hard layer and the hardness of the lower hard layer are independently no less than 80 HD.

In some embodiments, the hard layer includes hard PVC.

In a further aspect, the thickness of the abrasion-resistant layer is 0.1-1.0 mm.

According to another embodiment of the invention, a preparation method for an artificial tile is provided and includes: taking a glass magnesium plate as a substrate, and sequentially arranging structural layers of the above artificial tile on the glass magnesium plate.

In a further embodiment, the invention further provides an application of the artificial tile or an artificial tile prepared by using the above preparation method as a building decoration material.

The artificial tile of embodiments of the present invention includes a glass magnesium plate, an upper hard layer, a lower hard layer, and a UV layer disposed on the surface of the upper hard layer, where the upper hard layer and the lower hard layer are disposed on the upper surface and the lower surface of the glass magnesium plate respectively. In the present invention, the hard layer is disposed between the glass magnesium plate layer and the UV layer, so that the hard layer can not only serve as a connecting layer to promote the connection between the UV layer and the glass magnesium plate, but also serve as a supporting layer to offset the influence of temperature and external force on the glass magnesium plate, to prevent the glass magnesium plate from being deformed under the action of the temperature or the external force, thereby making the conventional UV layer also have anti-scratch and anti-slip functions while having an antifouling function. Results of the embodiment show that compared with a conventional wooden floor, the artificial tile provided by the present invention improves anti-scratch and anti-slip performance by nearly five times compared to conventional designs.

### BRIEF DESCRIPTION OF THE DRAWINGS

Various additional features and advantages of the invention will become more apparent to those of ordinary skill in the art upon review of the following detailed description of one or more illustrative embodiments taken in conjunction with the accompanying drawings. The accompanying drawings, which are incorporated in and constitutes a part of this specification, illustrate one or more embodiments of the invention and, together with the general description given above and the detailed description given below, explain the one or more embodiments of the invention.

FIG. 1 is an exploded view of an artificial tile structure according to one embodiment of the invention.

FIG. 2 is an exploded view of an artificial tile structure according to another embodiment of the invention.

FIG. 3 is an exploded view of an artificial tile structure according to a further embodiment of the invention.

### DETAILED DESCRIPTION

The following clearly and completely describes the technical solutions in the embodiments of the present invention with reference to the accompanying drawings in the embodiments of the present invention. To make objectives, features, and advantages of the present invention clearer, the following describes embodiments of the present invention in more detail with reference to accompanying drawings and specific implementations.

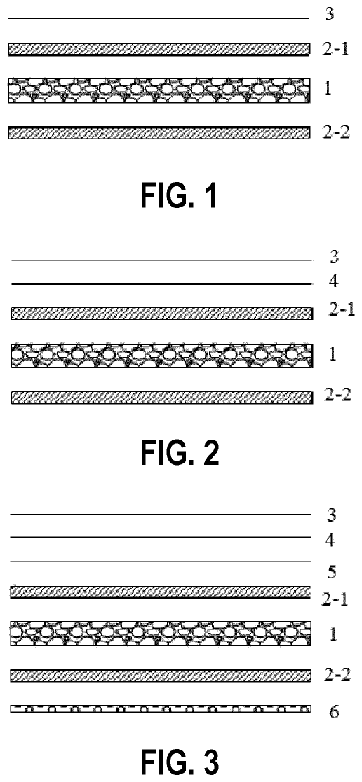

In one embodiment, the present invention provides an artificial tile, as shown in FIG. 1, including a glass magnesium plate 1, an upper hard layer 2-1 and a lower hard layer 2-2, and a UV layer 3 disposed on the surface of the upper hard layer, where the upper hard layer 2-1 and the lower hard layer 2-2 are disposed on the upper surface and the lower surface of the glass magnesium plate, respectively.

The artificial tile includes a glass magnesium plate, and the glass magnesium plate is preferably a man-made ore plate commercially available from Suqian Tianyi Technology Co., Ltd. When the artificial tile is used as a building decoration material, the thickness of the glass magnesium plate is preferably 2.8-3.2 mm, and more preferably 3.0-3.1 mm; when the artificial tile is used as a decorative material in other fields, the thickness of the glass magnesium plate can be set within the above thickness range or beyond the above thickness range according to specific application conditions. No special requirement is needed for the shape and size of the glass magnesium plate, and the shape and size can be set according to actual needs.

In this embodiment, the artificial tile includes an upper hard layer and a lower hard layer which are disposed on the upper surface and the lower surface of the glass magnesium plate respectively. The upper surface and the lower surface of the glass magnesium plate of the present invention are only for distinguishing the positional relationship of the structural layers of the artificial tile, and have no other special meaning.

The hardness of the upper hard layer and the hardness of the lower hard layer are independently preferably no less than 80 HD, more preferably 80-85 HD, and still more preferably 82-84 HD; and further, the hardness of the upper hard layer and the hardness of the lower hard layer are preferably the same. When the hardness of the upper hard layer and the hardness of the lower hard layer are different, the difference between the hardness of the upper hard layer and the hardness of the lower hard layer is preferably not more than 5 HD.

Materials of the upper hard layer and the lower hard layer preferably include rigid PVC independently; and further, the materials of the upper hard layer and the lower hard layer are preferably the same.

The thickness of the upper hard layer and the thickness of the lower hard layer are independently preferably 1.5-2.5 mm, more preferably 1.8-2.3 mm, and still more preferably 2.0-2.1 mm; and the thickness of the upper hard layer and the thickness of the lower hard layer are preferably the same. When the thickness of the upper hard layer and the thickness of the lower hard layer are different, the difference between the thickness of the upper hard layer and the thickness of the lower hard layer is preferably not more than 0.10 mm. The thickness of the upper hard layer and the thickness of the lower hard layer are set for the artificial tile as a building decoration material, and if the artificial tile is used in other fields, the thickness may be set beyond the above range according to actual needs.

The artificial tile includes a UV layer disposed on the surface of the upper hard layer. The UV layer preferably includes a primer and finishing coats, the primer preferably being a hardened primer; and the finishing coats preferably include two finishing coats, the two finishing coats being independently preferably hardened scratch-resistant finishing coats. The present invention has no special requirement for the composition of a coating forming the UV layer, as long as the above functions are available. In a specific embodiment of the present invention, the coating forming the UV layer is preferably a commercially available product of AkzoNobel Coating (Jiaxing) Co., Ltd.

The artificial tile has the following structure, which includes a UV layer, an upper hard layer, a glass magnesium plate and a lower hard layer in sequence from top to bottom, where the upper hard layer can serve as a connection layer of the UV layer, so that the UV layer is better connected to the glass magnesium plate, and the upper hard layer can also serve as a supporting layer to offset the influence of temperature and external force on the glass magnesium plate, to prevent the glass magnesium plate from being deformed under the action of the temperature or the external force, thereby making the conventional UV layer also have anti-scratch and anti-slip functions while having an antifouling function.

The artificial tile preferably further includes an abrasion-resistant layer and/or a color layer disposed between the upper hard layer and the UV layer.

The abrasion-resistant layer is disposed between the upper hard layer and the UV layer, so that the abrasion resistance of the artificial tile can be improved. The abrasion resistance of the abrasion-resistant layer is in accordance with the test requirements of EN 660-2, and the number of abrasion resisting turns is 2,000-50,000 r, more preferably 5,000-45,000 r, and still more preferably 10,000-40,000 r; the abrasion-resistant layer is preferably provided by a PVC transparent sheet, and more preferably a hardened PVC transparent sheet; and the thickness of the abrasion-resistant layer is preferably 0.1-1.0 mm, more preferably 0.2-0.8 mm, and still more preferably 0.30-0.35 mm.

The color layer is disposed between the upper hard layer and the UV layer to enrich the brightness and color of the artificial tile. Through the selection of the UV layer, the appearance of the artificial tile is the same as that of a marble tile, thereby obtaining an artificial marble tile; and artificial tiles with different brightness degrees such as highlight, matte and dark can also be obtained through the setting of the UV layer, which enriches performance of the artificial tiles.

When the abrasion-resistant layer and the color layer are disposed between the upper hard layer and the UV layer, the abrasion-resistant layer is preferably connected with the upper hard layer, and the color layer is preferably connected with the UV layer, to ensure that the UV layer works normally.

The artificial tile preferably further includes a back cushion disposed on the surface of the lower hard layer, and the back cushion comes into direct contact with the ground to play the role of buffering and damping, further improving the use performance of the artificial tile.

In another embodiment, a method is provided for preparing the artificial tile according to the above technical solution. The method includes: using a glass magnesium plate as a substrate, and sequentially arranging structural layers of the artificial tile according to the above technical solution on the glass magnesium plate.

In the artificial tile, a manner in which the hard layer is disposed preferably includes bonding; a manner in which the UV layer is disposed is preferably coating; a manner in which the abrasion-resistant layer and the color layer are disposed independently preferably includes thermal compounding; and a mode in which the back cushion is disposed preferably includes bonding.

The present invention has no particular requirements for the specific manners of the bonding, the coating, the thermal compounding and the bonding, and the structural layers which satisfy the above technical solution can be obtained by the manners well known to those skilled in the art.

In another embodiment, an application of the artificial tile described in the above technical solution is provided. The artificial tile provided by the present invention has good universality, and has no special requirements for a specific application mode, and can be used in a manner well known to those skilled in the art.

In order to further illustrate the embodiments of the invention, the artificial tile and the preparation method and application thereof provided by the present invention are described in detail below with reference to the accompanying drawings and embodiments, but the accompanying drawings and the embodiments should not be construed as limiting the protection scope of the present invention.

### Embodiment 1

A glass magnesium plate commercially available from Suqian Tianyi Technology Co., Ltd was taken as a substrate, and hard PVC plates with a thickness of 2.00 mm and a hardness of 80 HD were bonded to the opposite sides of the glass magnesium plate to form an upper hard layer and a lower layer; the upper hard layer was coated with a UV coating, and the UV coating was a commercially available product of AkzoNobel Coating (Jiaxing) Co., Ltd.; a UV layer was formed after the drying, and the artificial tile with the structure including a UV coating 3, the upper hard layer 2-1, the glass magnesium plate 1 and the lower hard layer 2-2 was obtained, as shown in FIG. 1.

### Embodiment 2

Structural layers including an upper hard layer, a glass magnesium plate and a lower hard layer were prepared in the same manner as in Embodiment 1, and then a hardened PVC sheet was placed on the upper hard layer to form an abrasion-resistant layer having a thickness of 0.30 mm after thermal compounding; the abrasion-resistant layer was coated with a UV coating (from AkzoNobel Coating (Jiaxing) Co., Ltd.), and the coating manner was the same as that in Embodiment 1; a UV layer was formed after the drying, and the ceramic tile structurally including the UV layer 3, the abrasion-resistant layer 4, the upper hard layer 2-1, the glass magnesium plate 1 and the lower hard layer 2-2 was obtained, as shown in FIG. 2.

### Embodiment 3

Materials structurally including an upper hard layer, a glass magnesium plate and a lower hard layer were prepared in accordance with the manner in Embodiment 1, a color layer PVC plate and a transparent sheet layer were sequentially disposed on the upper hard layer, and an abrasion-resistant layer with a thickness of 0.35 mm was formed after thermal compounding; a back cushion was bonded to the surface of the lower hard layer, and an artificial tile structurally including a UV layer 3, the abrasion-resistant layer 4, the color layer 5, the upper hard layer 2-1, the glass magnesium plate 1, the lower hard layer 2-2 and the back cushion 6 was prepared, as shown in FIG. 3.

### Embodiment 4

An artificial tile was prepared in accordance with the method of Embodiment 3. The difference was that no abrasion-resistant layer was prepared, and the artificial tile structurally including a UV layer, a color layer, an upper hard layer, a glass magnesium plate and a lower hard layer was obtained.

### Reference Example 1

A floor board which was commercially available from Anji Tianzhen Bamboo Flooring Co., Ltd., with the product number IP325080-1, and with a UV layer on the surface was taken as a reference sample.

### Reference Example 2

An existing polished tile (including clay and quartz) was used as a reference sample.

### Reference Example 3

A sample was prepared in the same manner as in Embodiment 1, and a UV layer could not be formed on a glass magnesium plate without providing a hard layer.

### Performance Test and Results

The scratch resistance of the products obtained in the embodiments and the reference examples was tested according to the EN 1964-2012 standard.

The slip resistance of the products obtained in the embodiments and the reference examples was tested according to the ANSI A137.1 standard.

The dimensional stability of the products obtained in the embodiments and the reference examples was tested according to the ASTM F2199 standard.

The surface antifouling property of the products obtained in the embodiments and the reference examples was tested according to the GB/T17657-2013 4.40 standard.

Through the evaluation of 20 experiencers, the comfort in touch with the feet and thermal insulation properties of the embodiments and reference samples were qualitatively tested, where the comfort in touch was divided into soft, hard, and moderate. The thermal insulation properties were divided into excellent, good, and poor. The above qualitative test used the results with the high number of votes as the final test results of the test samples; and the test results are shown in Table 1.

TABLE 1
Performance testing results of embodiments and reference examples

| Product | Embodiment | Embodiment | Embodiment | Embodiment | Reference | Reference |
|---|---|---|---|---|---|---|
| performance | 1: | 2: | 3: | 4: | example 1 | example 2 |
| Scratch | Level 1 | Level 1 | Level 1 | Level 2 | Level 2 | Level 2 |
| resistance | | | | | | |
| Slip | 0.46 | 0.48 | 0.50 | 0.48 | 0.37 | 0.28 |
| resistance | | | | | | |
| Antifouling | Level 5 | Level 5 | Level 5 | Level 4 | Level 4 | Level 5 |
| property | | | | | | |
| Dimensional | 0.02% | 0.02% | 0.01% | 0.01% | 0.05% | 0.02% |
| stability | | | | | | |
| Touch with | Moderate | Moderate | Moderate | Moderate | Soft | Hard |
| the feet | | | | | | |
| Thermal | Excellent | Excellent | Excellent | Excellent | Good | Poor |
| insulation | | | | | | |
| property | | | | | | |

It can be seen from the test results of Table 1 that the UV layer of the artificial tile provided by the present invention not only maintains the original antifouling property, but also improves anti-scratch and anti-slip performance.

In summary, by disposing the hard layer on the glass magnesium plate, the UV layer can be connected with the glass magnesium plate through the hard layer, so that the UV layer further has anti-scratch and anti-slip functions on the basis of ensuring an original antifouling property of the UV layer; the arrangement of the abrasion-resistant layer further improves abrasion resistance of the artificial tile; the arrangement of the color layer makes the artificial tile close to the color and brightness of marble, forming an artificial marble tile, which enriches attributes of the artificial tile; and the back cushion can improve the comfort in touching the artificial tile by the feet.

The preparation method for the artificial tile provided by the present invention is simple and suitable for large-scale production and use.

The artificial tile provided by the present invention has good universality and can be used in many fields.

Several examples are used for illustration of the principles and implementation methods of the present invention. The description of the embodiments is used to help illustrate the method and its core principles of the present invention. In addition, those skilled in the art can make various modifications in terms of specific embodiments and scope of application in accordance with the teachings of the present invention. In conclusion, the content of this specification shall not be construed as a limitation to the invention.

The embodiments described above are only descriptions of preferred embodiments of the present invention, and do not intended to limit the scope of the present invention. Various variations and modifications can be made to the technical solution of the present invention by those of ordinary skills in the art, without departing from the design and spirit of the present invention. The variations and modifications should all fall within the claimed scope defined by the claims of the present invention.

What is claimed is:

1. An artificial tile, comprising:
a glass magnesium plate,
an upper hard layer disposed on an upper surface of the glass magnesium plate,
a lower hard layer disposed on a lower surface of the glass magnesium plate, and
a UV layer disposed on a surface of the upper hard layer.

2. The artificial tile of claim 1, further comprising:
a back cushion disposed on a surface of the lower hard layer.

3. The artificial tile of claim 1, wherein a thickness of the upper hard layer and a thickness of the lower hard layer are each 1.5-2.5 mm.

4. The artificial tile of claim 1, wherein a hardness of the upper hard layer and a hardness of the lower hard layer are each no less than 80 HD.

5. The artificial tile of claim 4, wherein the upper hard layer and the lower hard layer comprise hard PVC.

6. The artificial tile of claim 1, further comprising at least one of:
an abrasion-resistant layer and a color layer, which is disposed between the upper hard layer and the UV layer.

7. The artificial tile of claim 6, further comprising:
a back cushion disposed on a surface of the lower hard layer.

8. The artificial tile of claim 6, wherein a thickness of the abrasion-resistant layer is 0.1-1.0 mm.

9. The artificial tile of claim 6, wherein when both of the abrasion-resistant layer and the color layer are arranged between the upper hard layer and the UV layer, the abrasion-resistant layer is connected with the UV layer, and the color layer is connected with the upper hard layer.

10. The artificial tile of claim 9, further comprising:
a back cushion disposed on a surface of the lower hard layer.

11. The artificial tile of claim 9, wherein a thickness of the abrasion-resistant layer is 0.1-1.0 mm.

12. A preparation method for an artificial tile, comprising:
providing a glass magnesium plate as a substrate, and
sequentially arranging structural layers of the artificial tile on the glass magnesium plate, specifically an upper hard layer to be disposed on an upper surface of the glass magnesium plate, a lower hard layer to be disposed on a lower surface of the glass magnesium plate, and a UV layer to be disposed on a surface of the upper hard layer.

13. The method of claim 12, further comprising:
arranging at least one of an abrasion-resistant layer and a color layer to be disposed between the upper hard layer and the UV layer.

14. The method of claim 13, wherein when both of the abrasion-resistant layer and the color layer are arranged between the upper hard layer and the UV layer, the abrasion-resistant layer is connected with the UV layer, and the color layer is connected with the upper hard layer.

15. The method of claim 14, further comprising:
arranging a back cushion to be disposed on a surface of the lower hard layer.

16. The method of claim 12, further comprising:
arranging a back cushion to be disposed on a surface of the lower hard layer.

17. An application of the artificial tile of claim 1 as a building decoration material.

18. An application of the artificial tile of claim 6 as a building decoration material.

19. An application of the artificial tile of claim 9 as a building decoration material.

20. An application of an artificial tile prepared by using the preparation method of claim 12 as a building decoration material.
